(19) United States
(12) Patent Application Publication
(10) Pub. No.: US 2020/0189831 A1
(43) Pub. Date: Jun. 18, 2020

(54) ADJUSTABLE INSULATOR

(71) Applicants: Bruno Stephen BERTHELOT, Arcadia, Magnetic Island (AU); Warren THOMPSON, Nelly Bay, Magnetic Island (AU); Kaye Michelle THOMPSON, Nelly Bay, Magnetic Island (AU); Shannon James Yanelle BERTHELOT, Miyazaki (JP)

(72) Inventor: Bruno Stephen Berthelot, Arcadia (AU)

(21) Appl. No.: 16/608,905

(22) PCT Filed: Apr. 27, 2018
(86) PCT No.: PCT/AU2018/050395

§ 371 Date: Oct. 28, 2019

(30) Foreign Application Priority Data
Apr. 28, 2017 (AU) 2017901546
May 5, 2017 (AU) 2017901646

(51) Int. Cl. B65D 81/38; B32B 3/28; B32B 29/08; B32B 7/05; A47G 23/02

(52) U.S. Cl. CPC B65D 81/3876; B32B 3/28; B32B 29/08; B32B 7/05; B32B 2307/732; A47G 23/0266; B65D 2203/02; B32B 2307/304; A47G 23/0241

(57) ABSTRACT

The invention provides an adjustable insulator for use with a can or bottle of drink, including a substantially planar body having a first end and a second end. The adjustable insulator includes adjustment means associated with the substantially planar body, including a first adjustment means part, associated with the first end of the substantially planar body, and a second adjustment means part, associated with the second end of the substantially planar body. The first and second parts together can adjustably connect so the first adjustment means part and second adjustment means part reciprocally connect in an adjustable manner for use about the can or bottle. The invention also relates to variants thereon and a method of use.

### FIELD OF THE INVENTION

The present invention relates to an adjustable insulator, and in particular to an adjustable insulator for use with cans or bottles.

The inventor has developed various items, in particular sophisticated cardboard items, subject of numerous patent applications. These cardboard items, have a variety of uses but one particularly advantageous use is as an insulating item, for cans and bottles. The inventor has now developed, in the subject invention one aspect further, to create a fully adjustable insulator, that may be used with a wide range of curved containers such as cans and bottles. This exceedingly clever invention enables the fully adjustable insulator to be assembled and held in place without the need for adhesive or a gluing step, a significant improvement in the art. The resultant product is therefore very economic, simple to produce, easy to assemble, lightweight, readily transported, and can be printed or labelled for promotional purposes. All-in-all the product is a surprisingly highly beneficial and desirable product, that is likely to be very widely sought after by beverage producers and others, and in fact early steps into these markets has met a ver positive response.

Other forms of drink cooler are known, such as rigid polystyrene or neoprene. These may be used at home or in bars and hotels where they can be returned to the owner and reused. Both polystyrene or neoprene coolers, or “stubby holders” as they called in Australia, are relatively expensive to manufacture, which is generally undesirable for promotional products or coolers for events, given away. Further, when stored or transported both polystyrene and neoprene coolers take a considerable volume of space which limits the transportability of the item. Use of cardboard enables the product to be manufactured very economically, stored flat and assembled as and when required. The space required to transport large numbers of these items is small as they compact down flat. The items are also light enough to transport by plane, and can be used in small or large numbers equally well. All these advantages of a lightweight, cheaply produced product, readily transported and assembled make cardboard the perfect material. However, use of standard cardboard does not create a suitable curve to surround a standard size can or bottle. It is simply not possible to get standard cardboard to work as a cooler, as it will not curve sufficiently to surround the item. The inventor has developed an arrangement of cardboard that will work as an insulator or cooler, and in the subject invention this is used in an adjustable, glue free manner to further improve the means of closing the insulator tightly around a can or bottle. The insulator will in the main be used to keep a cold drink cool and act as a cooler. However, the insulating properties of the invention mean that the insulator can also be used to keep items warm, maintain temperature or simply isolate the heat of the fingers of the user from the item.

Use of single-face cardboard or similar is a beneficial aspect as is use of the corrugations to insulate and enable moisture and condensation to quickly flow away. B flute and E flute single-face cardboard, in particular, have been found to be useful, as are other forms of suitable single faced cardboard. Other sizes of flutes such as C and D could also be used, or any suitable flute size. These flute sizes are standardised in the industry, but variations could also be used, to tailor to a particular use or needs of the user. It is envisaged that other forms of cardboard, and possibly double faced cardboard could also be used, in other forms of the invention. However, use of single-faced cardboard with a suitable sized flute does work best for standard cans and drink bottles.

Moisture handling can be critical with cardboard products, as if they go soggy then they will not be functional, or desirable for purchase or use in the future. The specific design of the subject invention, in some variants with a water resistant coating, drains away the moisture to keep the cardboard in excellent working condition.

The inventor has developed, through careful experimentation and research, a completely new design that enables the benefits of cardboard to be utilised to provide an extremely useful drink insulator, that can quickly and easily be used to different sized containers and adjusted and tightened to provide a tight fit. The invention is a significant advance over the prior art and over the other forms of invention of the inventor.

### BACKGROUND OF THE INVENTION

The following describes a non-limiting example of the invention being used with reference to use as an adjustable insulator for cans and bottles of drink, in particular to keep cold drinks cold. The invention may be used adjustably to protect or insulate any suitable item. Use for hot or cold drinks is a particularly useful application of the invention, and one that is likely to be very well received. However, it is not intended that the invention be limited to use for a can or bottle of drink, other than as limited in the claims. The adjustable insulator may also be used to insulate hot drinks, cups or vessels, or simply to insulate the fingers of the person drinking from the container. Further, the use of B or E flute single-faced cardboard has been used as particularly useful examples of the invention. However, other flutes or forms of cardboard may be used instead. It is not intended to limit the scope of the invention to particular flutes of cardboard, other than as defined in the claims.

For clarity, any prior art referred to herein, does not constitute an admission that the prior art forms part of the common general knowledge, in Australia or elsewhere.

It is an object of the present invention to provide an adjustable insulator that at least ameliorates one or more of the aforementioned problems of the prior art. It is a further object of the invention to provide a method of assembly of an adjustable insulator that at least ameliorates one or more of the aforementioned problems of the prior art.

### DISCLOSURE OF THE INVENTION

Accordingly, the present invention provides, an adjustable insulator for use with a can or bottle of drink, the adjustable insulator including:
a substantially planar body that may be assembled for use about or around the can or bottle to provide insulation;
adjustment means associated with the substantially planar body, including a first adjustment means part, and a second adjustment means part, the first and second parts together can adjustably connect,
   wherein, the first adjustment means part and second adjustment means part reciprocally connect in an adjustable manner for use about the can or bottle, and once adjusted to a suitable position the adjustment means substantially prevents the disassembly of the first adjustment means part and the second adjustment means part, whereby the adjustable insulator is maintained in an assembled state at a particular adjustment.

Accordingly, the present invention provides an adjustable insulator, in a variant, for use with a can or bottle of drink, the adjustable insulator including:
a substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
   wherein, the first adjustment means part and second adjustment means part reciprocally connect in an adjustable manner for use about the can or bottle.

Preferably, once adjusted to a suitable position the connection of adjustment means substantially prevents the disassembly of the first adjustment means part and the second adjustment means part until further adjustment is desired. Preferably, readjustment is readily possible of the adjustable insulator and then again the insulator is maintained in the adjusted position.

Most preferably, the substantially planar body is made of E flute single faced cardboard material. The substantially planar body may also be made of a B flute single faced cardboard material. Preferably, the substantially planar body is made of single faced cardboard material.

Preferably, the insulation is to insulate a container of drink. The container may be a cold drink and the insulator assists to keep the drink cool during consumption. The insulator may also be used with hot beverages to maintain heat during consumption. Preferably, the insulator is used in the form of a “stubby holder” or cooler for a can or bottle of drink. The insulator may be used with any suitable item. The insulator may insulate from impact and protect an item, such as an electronic item, in another form of the invention. The insulator may protect an item, the insulation being the insulation from impact or other problems from which the item may require protection.

Preferably, the can or bottle is a can or bottle of drink to be consumed direct from the bottle or can. The can or bottle may contain any suitable drink. The can or bottle may contain water. The can or bottle may contain an alcoholic beverage. The can or bottle may be a can or bottle of beer. The can or bottle may contain a mixed alcoholic beverage. The can or bottle may be a standard, single serving size for personal consumption. The can or bottle may be a larger size, for shared consumption. The bottle may be a bottle of wine. The bottle of wine may be an individual serving bottle. The bottle of wine may be a full sized bottle of wine. The bottle may be a bottle of any suitable size it is desired to keep cool, suitable to fit within the adjustable cooler. The insulator may be used with any suitable item or container.

The adjustability is preferably, to adjust to fit well around the body of the can or bottle. Preferably, the adjustability enables a tight fit around the item. The adjustability may enable a single adjustable insulator be used with a range of items of different diameters. The adjustability may enable both cans and bottles to be used with the cooler. The adjustability may enable a wide range of items of different dimensions to be used with the adjustable insulator. Most preferably, the same adjustable insulator may be adjusted to be used with one dimension of item and then easily adapted for use with another item. In each form of adjustability the adjustment is preferably, to tightly surround the body of the item. Preferably, the adjustability maximises the insulating properties of the insulator. Preferably, the maximised insulation is through a tight fit of the body of the insulator around the body can or bottle. Preferably, the adjustability enables a tight fit of the insulator about the can or bottle. Preferably, the tight fit assists with insulation of the can or bottle. Preferably, the tight fit makes the adjustable insulator comfortable to use and hold.

The substantially planar body for multiple adjustable insulators may be cut or pressed from a single sheet during manufacture. Preferably, the substantially planar body includes corrugations. The corrugations, in one form of the invention may be limited to the adjustment means parts. However, it is most beneficial to use the insulating properties of the corrugations on at least one part of the substantially body, to insulate the contained can or bottle. It is intended that corrugated cardboard is defined as a substantially planar body, if there is any doubt in this regard.

Throughout the document cardboard is described as a particularly useful product for the invention. Any suitable material or combination of corrugated materials, not limited to cardboard per se, may be used instead. The substantially planar body, may be made of any material. Preferably, the substantially planar body includes corrugations. Preferably, the substantially planar body is made of any suitable corrugated material.

Preferably, the corrugations are provided by use of single faced corrugated cardboard. Preferably, in one form of the invention, the corrugations are provided by use of single face B flute corrugated cardboard. Most preferably, the substantially planar body is formed from single face E flute corrugated cardboard. Any suitable flute may be used. A narrow or microflute corrugation arrangement may be suitable for use with the invention. Preferably, the width of flute is in the range 1.6 to 3.2 millimetres. Preferably, the width of the flutes is less than 3.2 millimetres. Preferably, the flutes are substantially 1.6 millimetres wide. Preferably, the flutes are substantially 1.6 millimetres wide or slightly less. There may be more than 144 flutes per metre. Preferably, the number of flutes per metre is in the range of 144 to 305. Most preferably, the number of flutes per metre is substantially 300 per metre. Other ranges of flutes per metre may be used as suitable for the adjustable insulator. Flute configurations are standardised and used worldwide in standard formats. However, a variation to these particular forms may, of course, also be manufactured specifically and used for the invention.

Preferably, the corrugation are configured to run substantially vertically in use. In this manner moisture, such as through condensation, may run away. Preferably, use of the vertical corrugations acts against pooling of liquid which could make the cardboard damp and lose integrity. Preferably, the substantially vertical corrugations act to both insulate the can or bottle and to enable any moisture to run away and out of the insulator. Preferably, the entire adjustable insulator is made of single face corrugated material. Preferably, the entire adjustable insulator is made of single face corrugated card. Preferably, the entire adjustable insulator is made of single face E flute corrugated card. The entire adjustable insulator may also be made of single face B flute corrugated card. Preferably, the adjustable insulator can be formed from a single sheet or piece. Preferably, the adjustable insulator is formed of a single sheet or piece of single face corrugated cardboard of a suitable form, readily folded to create the adjustable insulator which is maintained in place in use without the need for glue or additional connection or adhesion.

Preferably, the substantially planar body is given a water resistant coating during manufacture. The coating may cover part or all of the surface. The water resistant coating may be wax. A plastic or similar covering may be used instead to assist to prevent ingress of water. In other forms of the invention the cardboard is itself made of a plastics material or composite material.

The card may be card made of any suitable medium. The colour of the product may be varied to suit the desires of the ultimate customer. In one form of the invention the colour of the cardboard used is natural, or earthy colours. These colours may provide an excellent backdrop for promotional or advertising material applied to the cooler. Preferably, suitable materials are incorporated during manufacture to produce coloured cardboard for use as the substantially planar body. Preferably, the body of the adjustable insulator is coloured. The colours chosen may be suitable for marketing a particular product or event. Preferably, the substantially planar body is coloured. Where corrugated cardboard is used preferably the corrugated cardboard itself is coloured. Preferably, the material of the substantially planar body is coloured itself, rather than colour just applied to the surface. Decoration may of course be applied to the surface. Preferably, corrugated cardboard has dye or colouring agent added during manufacture so that the cardboard is coloured. Any suitable colour, dye or material may be used for the body of the insulator. Most preferably, the substantially planar body is made of E flute single face corrugated card and manufactured to be coloured. The colour is intended to be integral to the material, not simply printed on. The graphic may be printed on top of the coloured material of the body.

The substantially planar body, in other forms of the invention may include some non-planar elements. These may be decorative or functional items. Where the item is used for promotional purposes, any suitable additional parts or features may be included.

Preferably, a plurality of substantially planar bodies may be manufactured at the same time. Preferably, a plurality of substantially planar bodies may be transported in a flat state, ready for assembly elsewhere. Preferably, the adjustable insulators may be adapted to take up only a small amount of space and be light-weight to facilitate transportation or storage before assembly. The product may be supplied in an assembled, partially assembled or disassembled form. For example, flat product may be supplied in a package to the venue where the product is to be used. The host may then assemble some adjustable insulators ready for use. Other adjustable insulators may be provided disassembled ready to be assembled by the end user. The adjustable insulator may also be used and reused and may be disassembled between use. Once assembled the adjustable insulator may be readily disassembled, and reassembled as required. For example, where first one kind of drink is taken at an event the adjustable insulator may be taken and adjusted for use with that drink container. When the person then changes to a different form of drink container, the same adjustable insulator may be adjusted to fit the new and different drink container, by the person. The adjustment may be in a small and simple movement, readily achieved during an event, to comfortably move from use for one size of container to use for another. The adjustment may be from a wide range of precise adjustments available enabling precise adjustment to suit the particular container to be insulated.

Preferably, the adjustable insulator is substantially flat before assembly and assembled to form a substantially cylindrical insulator into which a can or bottle of drink may be readily slid. The assembly is preferably a very easy simple assembly, through the clever design features of the invention.

The assembly may occur during manufacture, in some forms of the invention. However, preferably, assembly occurs at or around the time of sale or use, as mentioned above and may be by the host or customer. The assembly may be by the sales person or by the customer. The clever invention enables very quick and easy, adjustable assembly that will be able to achieved by anyone, a great benefit of the invention. Preferably, the assembly is by means by any of the methods of the invention described below. Preferably, the adjustable insulator is assembled suitable for the can or bottle to be slide easily into the insulator. The adjustment during assembly is preferable to make a size suitable to fit the can or bottle so it may be slid in easily but as a tight fit for good insulation. The adjustable insulator may be assembled about a can or bottle. The adjustable insulator may be assembled and the can or bottle slid in after assembly. The invention has many varied uses and applications, as would be understood in the industry.

Preferably, the substantially planar body is divided into a middle part with an upper and lower part on either side. Preferably, the upper part and lower part may be folded over the middle part during assembly to make a strip to surround the can or bottle. Preferably, the body is adapted to include reciprocal parts which when folded assist to maintain the insulator in an assembled state. These reciprocating parts may be a cut-out and part that fits into the cut-out and be held therein during assembly. A strip to surround the can or bottle may be formed in any suitable manner. Preferably, the assembly occurs with the corrugations of the cardboard facing downwards or outwards so that when folded together the upper and lower part cover the smooth surface of the middle part with their corrugated surfaces. Preferably, the entire adjustable insulator has corrugations outermost, once assembled. The strip may be formed in any suitable manner during assembly.

Preferably, the first end of the substantially planar body is an end of a middle part of the body. The first end may be any part of the body. Preferably, the second end of the substantially planar body extends from a middle part of the body. Again, the second end could be formed of any suitable part of the body. Preferably, the substantially planar body includes an upper, middle and lower part and the first end and second end are of the middle part and this is where the first and second part of the adjustment means are located. Alternative ends or arrangements may be used instead.

Preferably, the adjustment means enables the flat insulator to be maintained in an assembled state, suitable to receive a can or bottle. Preferably, the adjustment means enables the insulator to be assembled in a wide range of sizes to suit different sizes of bottle or can. Preferably, the adjustment means enables the two parts to be slid together and adjusted in size until a suitable size is found and on stopping the adjustment means substantially maintains the assembled insulator at that position, size or state. Preferably, use of a fine or narrow corrugation for the adjustment means enables a wide range of adjustments. Each small incremental corrugation enables small adjustments to be made to the assembled insulator. In this way small incremental adjustments can be made during assembly to create an adjustable insulator suitable for the item to be insulated or protected. Preferably, the insulator is fully adjustable, as is extremely useful to be an adjustable insulator for use on a wide range of containers. The adjustment through pushing in or pulling out of the second part against the first part (or vice versa) enables quick and easy adjustment to the insulator. Once released the adjustment and reciprocating parts cooperate to assist to hold the adjustable insulator in an assembled state. The corrugations themselves resist the parts pulling apart unless addition pressure is applied by a person to again lift or slide the corrugations over one another. Putting the container within the insulator applies a slight additional pressure to press the two parts of the adjustment means together, whereby they are held strongly together.

Markings may be included to assist to indicate the assembly point for standard sizes of can or bottle in some forms of the invention. For example, a particular beverage manufacturer may include a mark to show the position to adjust to for a particular product. A range of products may be indicated by markings to show where the adjustment should be made to, to assemble the insulator for use with that product.

Preferably, the first adjustment means part projects from the first end. Preferably, the associating is that the first adjustment means is formed in the end of the body. The association may be the joining of another piece or part to achieve the adjustable connection between the first and second parts. The first adjustment means part may take any suitable shape. The first adjustment means part may be in the form of a tongue or tab. The first adjustment means may have cut sides or edges to assist in the connection with the second adjustment means part. The adjustment means may be reversed, or may take a different form. However, the inventor has found the cooperating nature of the corrugated card, and in particular a narrow flute of corrugated card to be useful. The corrugations, together, hold in the position left as pushed over one another. The pressure of the can or drink once in place also assists to hold in place.

Preferably, the second adjustment means part projects from the second end. Preferably, the associating is that the second adjustment means is formed in the end of the body. The association may be the joining of another piece or part to achieve the adjustable connection between the first and second parts. The first and second adjustment means preferably project from the middle part of the substantially planar body. Preferably, the second adjustment means part is folded over during assembly. Preferably, where corrugated cardboard is used the folding over presents a corrugated surface upwards. Following the folding over of the second adjustment means part the upper and lower parts of the body may be folded over the second adjustment means part and over the upwards facing corrugated part. In a different form of the invention only the two reciprocating parts of the adjustment means may be made of corrugated material, but this form will not include the same insulating properties of use of all corrugated material.

Preferably, when assembled the second adjustment means part is in the form of a corrugated part within a pocket formed by the upper and lower parts being folded over the middle of the substantially planar body. The pocket assists to maintain the adjustable insulator in place. Preferably, the pocket forms part of the adjustment means. Preferably, the pocket with a corrugated surface forms a first part of the adjustment means for receiving the projecting corrugated part, which is adjusted and held in position. Preferably, the first part can readily and adjustably slide within the pocket to be adjusted to a suitable size for use. Preferably, one part of the adjustment means slides over and catches on the other part of the adjustments and catches and holds in place. Preferably, two corrugated surfaces form the adjustment means and slide over and catch on one another hold the adjustable insulator in place. Preferably, the corrugations provide stopping points at narrow, regular intervals which can be used to hold the adjustable insulator in that position.

The connection is preferably adjustable but once adjustment stops the assembled insulator is held in place. Adjustment can occur again then if found to be not quite at the right place. The connection between the first and second parts of the adjustable means may take any suitable form. Preferably, the adjustment is a temporary adjustment. Preferably, the adjustment is a readily achieved and readily readjusted adjustment which may be repeated many times as required. Preferably, the adjustment can be readjusted to suit different applications. Preferably, the adjustment can be readjusted many times as required by the user. Most preferably, the first and second parts of the adjustment means include corrugations which connect together. Preferably, the first and second parts of the adjustment means include corrugations which overlay one another one facing up and one facing down. Preferably, the corrugations interlock one with the other to enable an adjustable connection and then be held in place. Preferably, the interlocking is as shown in FIG. 7. Most preferably, no other closure or adjustment means are included, it is the corrugations that provide the useful, adjustable closure, without the need for any glue or other features. However, in some particular uses of the invention there may be variation, such as fixing in place of the cooler to one size.

Most preferably, the adjustable insulator is adjusted and holds in place for use without the need for glue or adhesive. In this way the adjustable insulator may be released and readjusted many times, an important step forward over the prior art.

Preferably, a window may be included. Preferably, the window is oval. The window may take any suitable shape. Preferably, a window may be included in the middle part. Preferably, one or more other part of the body includes a graphic viewable through the window once assembled. Preferably, the graphic is formed to be substantially the same shape as the window. The graphic may be oval in footprint. The graphic may take any suitable form or shape. The graphic may be printed. The graphic may be printed with an inline printer. The graphic may be a label added during manufacture or assembly. The graphic may be formed on the upper part of one surface of the substantially planar body whereby once folded the graphic can be viewed through the window. Preferably, the upper part includes a shaped part for containing the graphic. Preferably, the lower part includes a corresponding cut-out and on assembly these parts together form one side of the insulator.

Most preferably, the adjustable insulator may be used for promotional purposes and the graphic include branding or event information. A particular event, company, product or celebration may be reflected in the graphic used on the adjustable insulator.

Accordingly, the present invention provides, in a further variant, an adjustable insulator for use with a can or bottle of drink, the adjustable insulator including:
a substantially planar body of single face narrow flute corrugated cardboard that may be assembled for use about or around the can or bottle to provide insulation, the substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
   wherein, the first adjustment means part and second adjustment means part reciprocally connect by overlaying one corrugated face with another corrugated face so as the corrugations interlock in an adjustable manner for use about the can or bottle, and once adjusted to a suitable position the connection of adjustment means prevents the disassembly of the first adjustment means part and the second adjustment means part, assisted by the pressure of the can or bottle.

Accordingly, the present invention provides, in a variant, an adjustable insulator for use with a can or bottle of drink, the adjustable insulator including:
a substantially planar body of single face E flute corrugated cardboard that may be assembled for use about or around the can or bottle to provide insulation, the substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
   wherein, the first adjustment means part and second adjustment means part reciprocally connect by overlaying one corrugated face with another corrugated face so as the corrugations interlock in an adjustable manner for use about the can or bottle, and once adjusted to a suitable position the connection of adjustment means prevents the disassembly of the first adjustment means part and the second adjustment means part, assisted by the pressure of the can or bottle.

Accordingly, the present invention provides, in a variant, an adjustable insulator for use with a can or bottle of drink, the adjustable insulator including:
a substantially planar body of single face B flute corrugated cardboard that may be assembled for use about or around the can or bottle to provide insulation, the substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
   wherein, the first adjustment means part and second adjustment means part reciprocally connect by overlaying one corrugated face with another corrugated face so as the corrugations interlock in an adjustable manner for use about the can or bottle, and once adjusted to a suitable position the connection of adjustment means prevents the disassembly of the first adjustment means part and the second adjustment means part, assisted by the pressure of the can or bottle.

Accordingly, the present invention provides in a further aspect, an insulator for use with a can or bottle of drink, the insulator including:
a substantially planar body that may be assembled for use about or around the can or bottle to provide insulation;
adjustment means associated with the substantially planar body, including a first part, associated with a first end of the substantially planar body, and a second part, associated with a second end of the substantially planar body,
   wherein, the first and second parts together can connect one with the other and be held in place, to hold the insulator for use about the can or bottle without the need for glue or adhesive.

Accordingly, the invention provides in another aspect, an adjustable insulator for use with an item to protect it from damage or insulate from temperature, the adjustable insulator including:
a substantially planar body that may be assembled for use about or around the item, the substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
   wherein, the first adjustment means part and second adjustment means part reciprocally connect in an adjustable manner for use about the item, and once adjusted to a suitable position the connection of adjustment means prevents the disassembly of the first adjustment means part and the second adjustment means part.

Accordingly, the present invention provides, in a variant, an adjustable insulator for use with a can or bottle of drink, the adjustable insulator including:
a substantially planar body of single face narrow flute corrugated cardboard that may be assembled for use about or around the can or bottle to provide insulation, the substantially planar body;
adjustment means associated with the substantially planar body, including a first adjustment means part, and a second adjustment means part, the first and second parts together can adjustably connect,
   wherein, the first adjustment means part and second adjustment means part reciprocally connect by overlaying one corrugated face with another corrugated face so as the corrugations interlock in an adjustable manner for use about the can or bottle, and once adjusted to a suitable position the adjustment means prevents the disassembly of the first adjustment means part and the second adjustment means part whereby the adjustable insulator is maintained in an assembled state.

Accordingly, the present invention also provides a method of assembly of an adjustable insulator for a can or bottle, the adjustable insulator including a substantially planar body having a first end and a second end, and adjustment means associated with the substantially planar body, including a first adjustment means part, associated with the first end of the substantially planar body, and a second adjustment means part, associated with the second end of the substantially planar body, whereby the first and second parts together can adjustably connect for use about the can or bottle, the method of assembly including the following steps:

a) folding of the substantially planar body in three, lengthways to create a strip shape;
b) curving the strip to form a suitable size and shape for the can or bottle to be insulated;
c) connecting the first and second adjustment means parts together at that size and shape, whereby the connected insulator is held in place during use by the adjustment means.

Preferably, the substantially planar body is made of corrugated cardboard. Preferably, the substantially planar body is made of single face corrugated cardboard. Most preferably, the substantially planar body is made of single face E or B flute corrugated cardboard. It may be possible in other forms of the invention for the folding step to be replaced.

Preferably, an additional step is made before a) of folding the second part of the adjustment means so that the corrugations face upwards, whereby the first part of the adjustment means connects by having corrugations face downwards, so that the corrugations in use may overlay, connect and interlock. Preferably, the upper and lower parts of the body fold over a middle section, covering the second part, to create a receiving part for the first part of the adjustment means to slide into and connect. The facing direction of the corrugations of the first and second parts of the adjustment means may be reversed.

Preferably, the substantially planar body has an upper part, middle part and lower part and during step a) the upper part and lower part are folded towards one another over the middle part. Preferably, the upper part and lower part are adapted to correspond to one another to fit over the middle part. Preferably, the upper part includes a curved part and the lower part a cut-out adapted to receive the curved part, whereby during assembly the curved part fits into the cut-out part over the middle part to complete the strip. Preferably, the first part and second part together fit together and assist to maintain the strip shape, by holding together. Preferably, shaped parts of the body reciprocated when folded to assist to maintain in the assembled shape. Other forms of shape and cut-out may be correspondingly used instead. Where labels or printing are used the label or printing may be made on the upper part. The label or printing may be made in the curved part. Preferably, the middle part includes a window and on overlaying with the other parts a label or printing may be seen, through the window. Preferably, where a window is included the upper part includes a curved part including a graphic that on assembly can be seen through the window. Preferably, in this form of the invention, a cut-out on the lower part closes with the curved part to complete the strip and assist to hold the strip in the assembled state. In some forms of the invention the use of a cut-out and receiving part may be part of the adjustment means.

Preferably, the holding in place is without the need for any gluing or adhesive step.

Preferably, the connected insulator is substantially a perfect fit around the can or bottle. Preferably, the folding over of the body is held in place without the need for glue and the adjustment means forms a connection to hold in place without the need for glue.

The can or bottle may be replaced by any suitable item. Preferably, the substantially planar body is made of single face E flute corrugated cardboard. Alternatively B Flute or similar may be used instead. Any suitable narrow fluted corrugated cardboard may be used instead.

Throughout, use of single faced E or B flute corrugated cardboard is preferred. However, other corrugated materials may be used and these may include corrugated plastics or other similar materials with similar properties.

An inline printer may be used to print the label or image onto the insulator in any of the forms of the invention. An inline printer may be used to print on the substantially planar body before or during manufacture.

Preferably, in any of the forms of the invention the adjustable insulator may be adjusted, used and then readjusted for use again with a different container. For each of the methods described the adjustable insulator may be the adjustable insulator of the invention in any of its forms or variants.

### INDUSTRIAL APPLICABILITY

The product is manufactured industrially and supplied to wholesales, promotional companies or retailers for distribution or sale.

### BRIEF DESCRIPTION OF THE DRAWINGS

The invention will now be described in connection with a non-limiting preferred embodiment with reference to the accompanying drawings, in which:

FIG. 1 is a plan view from above of an adjustable insulator according to a preferred embodiment of the invention, in a flat pack state, prior to assembly (the can or bottle is omitted throughout for clarity of illustration);

FIG. 2 is a plan view of the adjustable insulator of FIG. 1, with the first step of assembly, folding in of adjustable receiving portion, so that the corrugated side 11 is facing upwards;

FIG. 3 is a plan view of the adjustable insulator of FIGS. 1 and 2, with the next step of assembly, folding up and over the middle portion;

FIG. 4 is a plan view of the adjustable insulator of FIGS. 1 to 3, with the next step of assembly, folding down over the middle portion;

FIG. 5 is a plan view of the adjustable insulator of FIGS. 1 to 4, turned over to show the label shown through the window;

FIG. 6 is a perspective view from the front of the adjustable insulator of FIG. 5, with the label visible through the window, being curved into a shape suitable for a can or bottle of drink, prior to adjustment; and

FIG. 7 is a detailed image of the adjustable portions whereby the projection and receiving portions both have corrugations so that these catch into one another and hold the adjustable insulator together without the need for additional attachment or adhesive.

### DETAILED DESCRIPTION OF THE INVENTION INCLUDING A BEST MODE

We note that use of the word “LABEL” is included in the drawings to particularly facilitate understanding of the invention.

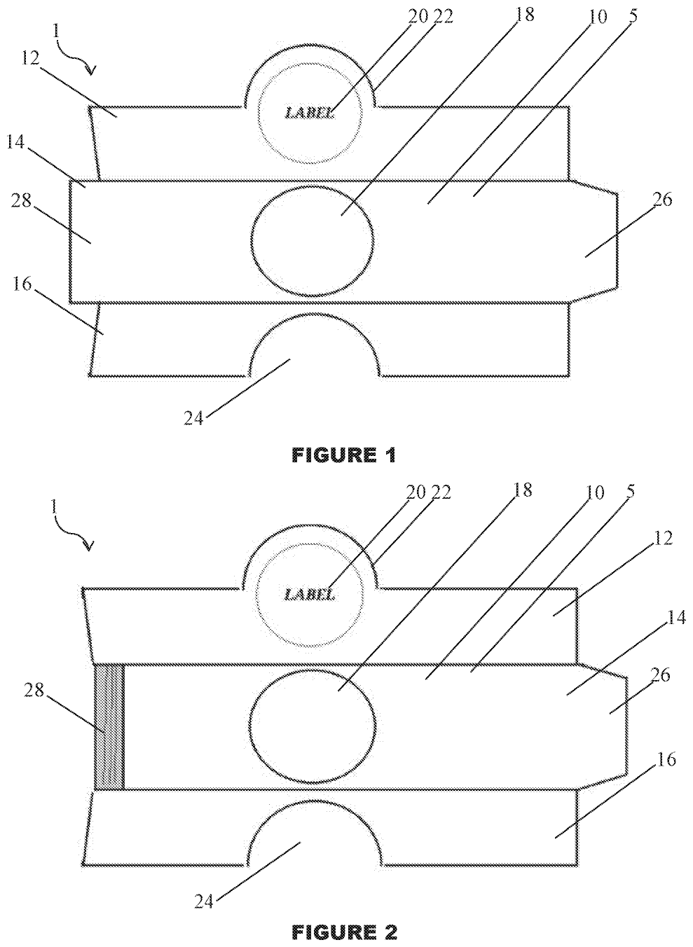

Referring to FIGS. 1 to 7, a preferred embodiment of the invention will be described, where adjustable insulator 1, has body 5 made of single face E Flute corrugated cardboard. Use of single face E flute corrugated card enables a suitable curve around a can or bottle be used and with the insulating properties provided by the air pockets in the cardboard. Other narrow flute forms of corrugated card are also suitable. For example, use of B flute has also been found to work well.

Body 5 has smooth side 10 and corrugated side 11 as can be seen clearly in the drawings. The corrugations are indicated approximately, and are intended to show E flute corrugations. These E flute corrugations are typically 1.6 millimetre thick flutes with 295 per linear metre with a margin of error of +/−13. Other flutes can be used such as B flute typically 3.2 millimetre thick flutes with 154 per linear metre with a margin of error of +/−10. Other flutes can be used but these forms have been found to work particularly well.

Planar body 5 is divided into three sections 12, the upper part, 14 the middle part and 16 the lower part which together make the flat body 5. Middle part 14 can be seen to include an oval window 18, through which label 20 on 12 can be viewed, once adjustable insulator 1 has been assembled. Upper part 12 includes a curved projection 22 to contain label 20. Lower part 14 includes a corresponding curved cut-out 24 to receive curved projection 22. Corresponding curved and cut-out portions 22 and 24 provide an elegant solution to the folding and flaps which fit together and due to the nature of the single face E flute cardboard, and maintains body 5 in the folded and corresponding arrangement. The thickness and inherent rigidity enable the curved assembled insulator 1 to have a strength to it that is useful and the parts act against one another to create this strength without the need for glue or adhesive. Other forms of cut out and reciprocating shape may be used and pressed together to hold the strip in place. The described has the added benefits of aligning the graphic and window, as well as pressing together to hold the strip together.

Middle part 14 also includes the adjustment mechanism formed of adjustable projection portion 26 and adjustable receiving portion 28, one at either end. Each projection, together enable adjustable connection in the assembled form. Adjustable projection portion 26 has cut-out or shaped sides to facilitate feeding into the “pocket” created by receiving portion 28 and the upper and lower parts of body 5. The pocket assists to form a back against which the rest of the adjustment means is held, further assisting to hold the insulator together, once assembled.

Referring to FIG. 1 adjustable insulator 1 is in the flat pack state, prior to assembly (the can or bottle is omitted throughout for clarity of illustration). The corrugated card would be cut or punched to produce numerous insulators in a single run. Once adjustable insulator 1 is ready for assembly, with smooth side 10 facing uppermost, adjustable receiving portion 28 is folded up and in so that the corrugated surface can be seen uppermost, as illustrated in FIG. 2.

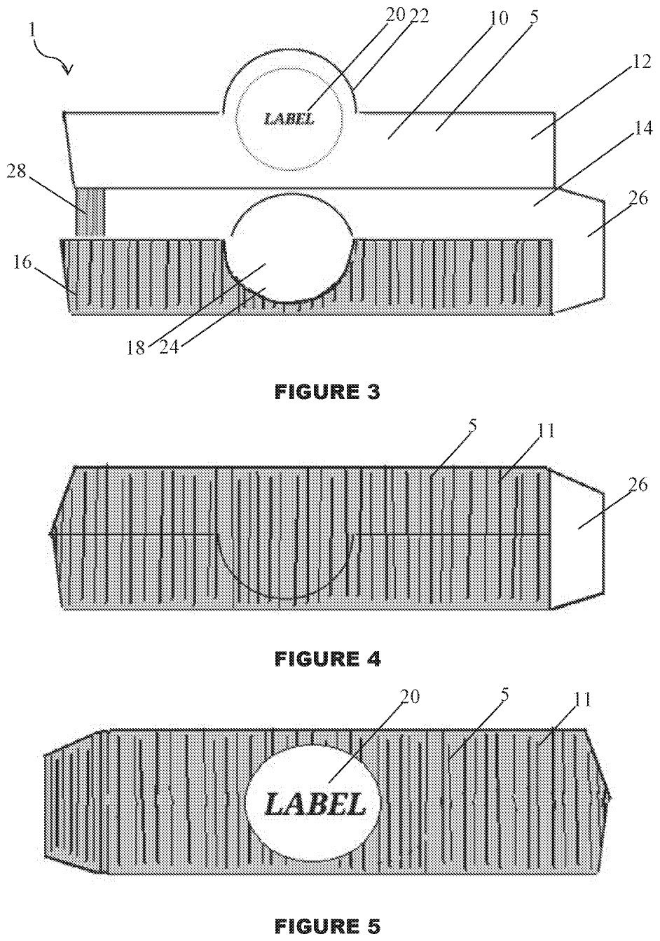

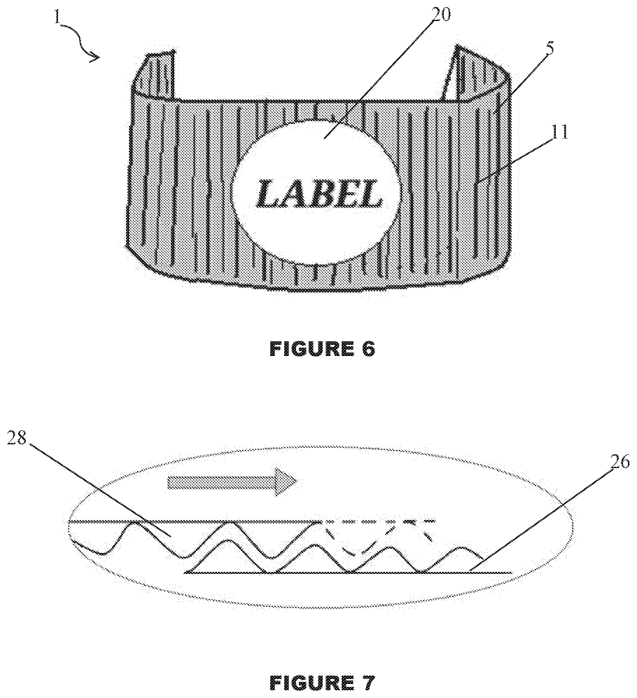

Referring to FIG. 3 the next step of assembly is shown, folding up of body part 16, the lower part, over middle body part 14. Curved cut-out 24 can be seen ready to receive curved projection 22 and fit together. This occurs at the next step seen in FIG. 4, shown fitting together in FIG. 4 and the rigidity of the cardboard means reciprocating curved cut-out 24 and receiving portion 28 fit neatly together, and have sufficient rigidity to hold the article together and assembled as seen in FIG. 6. FIG. 5 shows the reverse of FIG. 4 showing that as curved cut-out 24 and receiving portion 28 fit together, so label 20 is aligned with window 18 to display the information in the completed insulator 1, useful for advertising or promotional purposes. Again the reciprocating parts hold themselves together due to the clever design.

FIG. 6 also shows as the assembled strip of FIGS. 4 and 5 is curved this will fit around a can or bottle to provide the cooling and insulation necessary to keep a drink cool. The curve is able to be formed due to the nature and arrangement of the cardboard and then holds firmly together. As the strip is formed together into a curved shape, a cylinder, the tab of projection 26 with its corrugations connects and slides against the downward corrugations of receiving portion 28 contained by the upper 12 and lower 16 part of body 5 folded thereover. The connection of the two corrugated parts is important, as shown in FIG. 7, as they can slip over one another until the right size is achieved and then connected and held in place. Once the can or bottle is in place, the pressure assists to maintain the holder in the assembled position. This is due to the two corrugated parts being pressed further together, strengthening the grip, and “locking” insulator 1 in the assembled state. The pocket formed assists here too. After use, the removal of the can or bottle releases the pressure so that insulator 1 can again be disassembled. Insulator 1, can be adjusted, readjusted and reused many times and is not fixed in place as glued products would be. The readjustment and reusability of the product further improves the desirability of the adjustable insulator for events or promotions. A consumer may use the item many times at the event for use repeatedly with the same or different containers. The insulator may then be returned to the host for use again at another event or retained by the customer, who can themselves use the item repeatedly on other occasions. Overall the inventor has developed a very clever means to create from a flat sheet a very useful drinks cooler that is economic to produce, easily assembled for use promotionally or otherwise. It will be apparent to a person skilled in the art that changes may be made to the embodiment disclosed herein without departing from the spirit and scope of the invention in its various aspects.

### REFERENCE SIGNS LIST

| | |
|---|---|
| 1 | Adjustable Insulator |
| 5 | Body |
| 10 | Body smooth side |
| 11 | Body corrugated side |
| 12 | Body part 1 |
| 14 | Body part 2 |
| 16 | Body part 3 |
| 18 | Window |
| 20 | Label |
| 22 | Curved projection |
| 24 | Curved cut-out |
| 26 | Adjustable projection portion |
| 28 | Adjustable receiving portion |

1-29. (canceled)

30. An adjustable insulator, for use with a can or bottle of drink, the adjustable insulator including:
a substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
wherein, the first adjustment means part and second adjustment means part reciprocally connect in an adjustable manner for use about the can or bottle, and further wherein the adjustable insulator is substantially formed of a single sheet or piece of single face corrugated cardboard of a suitable form, readily folded to create the adjustable insulator which is maintained in place in use without the need for glue or additional connection or adhesion.

31. The adjustable insulator of claim 30, wherein the adjustable insulator is adjusted to a suitable position and the connection of adjustment means substantially prevents the disassembly of the first adjustment means part and the second adjustment means part until further adjustment is desired.

32. The adjustable insulator of claim 30, wherein readjustment is readily possible of the adjustable insulator and then again the insulator is maintained in the adjusted position.

33. The adjustable insulator of claim 30, wherein the substantially planar body is made of E flute or B flute single faced cardboard material.

34. The adjustable insulator of claim 30, wherein the adjustability is to adjust to fit well around the body of the can or bottle and enables a tight fit around the item.

35. The adjustable insulator of claim 30, wherein the adjustability enables a single adjustable insulator be used with a range of items of different diameters.

36. The adjustable insulator of claim 35, wherein narrow or microflute corrugations are used.

37. The adjustable insulator of claim 36, wherein the width of flute is in the range 1.6 to 3.2 millimetres.

38. The adjustable insulator of claim 36, wherein the width of the flutes is less than 3.2 millimetres.

39. The adjustable insulator of claim 36, wherein the width of flute is substantially 1.6 millimetres wide.

40. The adjustable insulator of claim 36, wherein there are more than 144 flutes per metre.

41. The adjustable insulator of claim 36, wherein the number of flutes per metre is in the range of 144 to 305.

42. The adjustable insulator of claim 36, wherein the number of flutes per metre is substantially 300 per metre.

43. The adjustable insulator of claim 30, wherein the substantially planar body is given a water resistant coating during manufacture.

44. The adjustable insulator of claim 30, wherein decoration, colour or a graphic is applied to the surface.

45. The adjustable insulator of claim 30, wherein the adjustment is from a wide range of precise adjustments available enabling precise adjustment to suit the particular container to be insulated.

46. The adjustable insulator of claim 30, wherein the adjustable insulator is substantially flat before assembly and assembled to form a substantially cylindrical insulator into which a can or bottle of drink may be readily slid.

47. The adjustable insulator of claim 30, wherein the assembly occurs with the corrugations of the cardboard facing downwards or outwards so that when folded together the upper and lower part cover the smooth surface of the middle part with their corrugated surfaces.

48. The adjustable insulator of claim 30, wherein the entire adjustable insulator has corrugations outermost, once assembled.

49. The adjustable insulator of claim 30, wherein the adjustment means enables the two parts to be slid together and adjusted in size until a suitable size is found and on stopping the adjustment means substantially maintains the assembled insulator at that position, size or state.

50. The adjustable insulator of claim 30, wherein the use of a fine or narrow corrugation for the adjustment means enables a wide range of adjustments and each small incremental corrugation enables small adjustments to be made to the assembled insulator.

51. The adjustable insulator of claim 30, wherein the first adjustment means part is in the form of a tongue or tab.

52. The adjustable insulator of claim 30, wherein when assembled the second adjustment means part is in the form of a corrugated part within a pocket formed by the upper and lower parts being folded over the middle of the substantially planar body.

53. The adjustable insulator of claim 30, wherein two corrugated surfaces form the adjustment means and slide over and catch on one another hold the adjustable insulator in place.

54. The adjustable insulator of claim 30, wherein adjustment can be readjusted many times as required by the user.

55. The adjustable insulator of claim 30, wherein the first and second parts of the adjustment means include corrugations which connect together and overlay one another one facing up and one facing down and the corrugations interlock one with the other to enable an adjustable connection and then be held in place.

56. An adjustable insulator for use with a can or bottle of drink, the adjustable insulator including:
a substantially planar body of single face narrow flute corrugated cardboard that may be assembled for use about or around the can or bottle to provide insulation, the substantially planar body having a first end and a second end;
adjustment means associated with the substantially planar body, including a first adjustment means part, associated with the first end of the substantially planar body, and a second adjustment means part, associated with the second end of the substantially planar body, the first and second parts together can adjustably connect,
wherein, the first adjustment means part and second adjustment means part reciprocally connect by overlaying one corrugated face with another corrugated face so as the corrugations interlock in an adjustable manner for use about the can or bottle, and once adjusted to a suitable position the connection of adjustment means prevents the disassembly of the first adjustment means part and the second adjustment means part, assisted by the pressure of the can or bottle.

57. A method of assembly of an adjustable insulator for a can or bottle, the adjustable insulator including a substantially planar body having a first end and a second end, and adjustment means associated with the substantially planar body, including a first adjustment means part, associated with the first end of the substantially planar body, and a second adjustment means part, associated with the second end of the substantially planar body, whereby the first and second parts together can adjustably connect for use about the can or bottle, the method of assembly including the following steps:
a) folding of the substantially planar body in three, lengthways to create a strip shape;
b) curving the strip to form a suitable size and shape for the can or bottle to be insulated;
c) connecting the first and second adjustment means parts together at that size and shape, whereby the connected insulator is held in place during use by the adjustment means and further wherein the adjustable insulator is formed of a single sheet or piece of single face corrugated cardboard of a suitable form, readily folded to create the adjustable insulator which is maintained in place in use without the need for glue or additional connection or adhesion.

58. The method of claim 57 wherein, the adjustable insulator is the adjustable insulator of claim 30.
